(19) United States
(12) Patent Application Publication
(10) Pub. No.: US 2005/0095520 A1
(43) Pub. Date: May 5, 2005

(54) Toner for electrostatic image development

(75) Inventors: Akihide Isoda, Neyagawa-shi (JP); Heihachi Yushina, Neyagawa-shi (JP)

Correspondence Address: PARKHURST & WENDEL, L.L.P., 1421 PRINCE STREET, SUITE 210, ALEXANDRIA, VA, 22314-2805, US

(73) Assignee: Orient Chemical Ind., Ltd., Neyagawa-shi (JP)

(21) Appl. No.: 10/968,011

(22) Filed: Oct. 20, 2004

(30) Foreign Application Priority Data
Nov. 5, 2003 (JP) 2003-376089

(51) Int. Cl. G03G 9/08

(52) U.S. Cl. 430/108.3; 430/108.24; 430/111.41

(57) ABSTRACT

A toner for electrostatic image development comprises components of a charge control agent, a binding resin, and colorant. The charge control agent is an aromatic-oxy-carboxylic acid iron-including compound. The toner has its particle size distribution with: a volume-average particle diameter (D₅₀) ranging from 5 to 13 microns that is determined by a cumulative 50% volume particle diameter from a largest particle diameter, and a degree of particle size dispersion (D₂₅/D₇₅) ranging from 1.20 to 1.50 that is calculated by a cumulative 25% volume particle diameter (D₂₅) and a cumulative 75% volume particle diameter (D₇₅) as same as the above determined D₅₀.

### BACKGROUND OF THE INVENTION

This invention relates to a negative toner for electrostatic image development including an aromatic-oxy-carboxylic acid iron-including compound for forming images onto a transcription sheet by an electrophotography method, an electrostatic recording method, a magnetic recording method and so on. And this invention relates to an image formation process using this toner.

The electrophotography method applies for copying by a copy machine, or printing an image data of a computer by a printer. The electrophotography method is performed by forming an electrostatic latent image on photosensitive frame having photoconductive materials by various exposure procedures, developing the latent image by the toner, forming a visual toner image, transferring the toner images onto the transcription sheet such as copying paper, and then fixing the toner image onto the transcription sheet by heat or pressure, to obtain the copied sheet. Besides, the electrostatic recording method, the magnetic recording method, and so on are known.

Throughput of the image data by the computer has been improved increasingly. And a laser-beam printer, a light emitting diode printer and the copying machine, which are able to form a fine image having high definition and high reliability more than ever, have been developed. Accordingly, it is desired that the performance of the toners used for the printer or the copying machine is improved more and more in order to form finer and more vivid image having higher definition.

For instance, the toners having particular particle diameters for improving the performance thereof are mentioned in Japanese Patent Provisional Publication Nos. 1-112253, 1-191156, 2-284158, 3-181952, and 4-162048.

When a volume-average particle diameter of the toner is large comparatively, the image lacks sharpness because of scattering of the toner particles in the neighborhood of the image on the transcription sheet.

When a weight-average particle diameter of the toner is large comparatively, definition of the image decreases gradually as the number of the transcription sheets that the images are formed repetitiously accumulates.

When the volume-average particle diameter of the toner is less than 5 microns, the image is sharp as the toner is fine comparatively. And the toner causes decreasing of fluidity thereof, decreasing of concentration of the solid black image, and increasing of fogginess of the image remarkably.

Moreover, the toner comprising a boron-including complex salt as a charge control agent and oxidant particles as an external additive agent for improving the performance thereof is mentioned in Japanese Patent Provisional Publication No. 6-250442. Because an amount of this toner and a quantity of electrification on a frame holding a developer have been stabilized and capacity of electrification has been improved, the toner is able to form the image having high definition.

When the toner is electrified by a layer formation blade, the toner is put under a lot of physical stress, because contact pressure towards the layer formation blade has been needed to increase. So the external additive agent is buried in a surface of the toner and causes transformation of an adhesive state. The capacity of the electrification by the external additive agent and the charge control agent decreases with the passage of time. Consequently, raising of the electrification slows. And the images maintaining the high definition are not formed continuously for a long period of time. Furthermore, the toner is scattered from the frame holding the developer to pollute the inside of a developing machine.

### SUMMARY OF THE INVENTION

The present invention has been developed to solve the foregoing problems. It is an object of the present invention to provide a toner for electrostatic image development, which causes a fast rise speed of electrification, an excellent electrification property, a vivid image maintaining high definition, high quality and little fogginess for a long period of time using thereof. It is another object of the present invention to provide an image formation process using this toner.

A toner for electrostatic image development of the present invention developed for accomplishing the foregoing object comprises components of a charge control agent, a binding resin, and colorant.

It is preferable that the charge control agent is an aromatic-oxy-carboxylic acid iron-including compound.

It is further preferable that the aromatic-oxy-carboxylic acid iron-including compound is a benzene-oxy-carboxylic acid iron-including compound or a naphthalene-oxy-carboxylic acid iron-including compound, that may be substituted solely or plurally by the same or different substitutional group selected from groups consisting of an alkyl group having 1 to 12 carbon atoms, an alkenyl group having 2 to 12 carbon atoms, —OH, —NH₂, —NH(CH₃), —N(CH₃)₂, —OCH₃, —O(C₂H₅), —COOH and —CONH₂.

The toner has its particle size distribution with:
a volume-average particle diameter (D₅₀) ranging from 5 to 13 microns that is determined by a cumulative 50% volume particle diameter from a largest particle diameter,
and a degree of particle size dispersion (D₂₅/D₇₅) ranging from 1.20 to 1.50 that is calculated by a cumulative 25% volume particle diameter (D₂₅) and a cumulative 75% volume particle diameter (D₇₅) as same as the above-determined D₅₀.

The toner for the electrostatic image development having this particle size distribution has comparatively even particle size thereof. Moreover, the toner causes maintaining of a quantity of the electrification for a long period of time, because the charge control agent in the particle of the toner is distributed onto surface of the toner evenly. The image is formed onto a transcription sheet such as copying paper using the toner by the electrophotography method and so on. At the occasion, the fine images having high definition, sharpness and no fogginess, are stably formed for the long period of time. When the images are repetitiously formed onto the transcription sheets of paper as many as the tens of thousands sheets, the definition of the images maintains high quality.

If the volume-average particle diameter (D₅₀) is less than 5 microns, the fluidity of the toner worsens remarkably. Therefore the image is formed insufficiently, and it causes the fogginess of the image or the pollution of the copying sheets. If the volume-average particle diameter (D₅₀) is more than 13 microns, the image having the high quality is not formed because of decreasing of the definition thereof.

If the degree of particle size dispersion of the toner (D₂₅/D₇₅) is more than 1.50, the particle diameter thereof is uneven comparatively. When the image is formed onto the copying paper in occasion of an initial stage, the high quality of the images is achieved. When the images are formed onto the copying paper repetitiously to accumulate the paper, the volume-average particle diameter and the quantity of the electrification fluctuate. Consequently, the images are not formed as high as the quality in the initial stage.

If the degree of particle size dispersion of the toner (D₂₅/D₇₅) is less than 1.20, the particle diameter thereof is even. For preparing of this toner, it is necessary to use a complicated large-scale apparatus and the preparing cost thereof is expensive. Further, the quality of the images is not improved so much, and it is not useful.

It is enough that the range of the degree of particle size dispersion of the toner (D₂₅/D₇₅) is 1.20 to 1.50, for forming the images having the high definition.

The content of the aromatic-oxy-carboxylic acid iron-including compound in the toner for the electrostatic image development is 0.2 to 5 weight parts, preferably 0.3 to 3 weight parts to 100 weight parts of the binding resin. If the content of the aromatic-oxy-carboxylic acid iron-including compound exceeds this range, the fluidity thereof worsens. So when the images are formed, the images cause the fogginess. If the content is less than this range, the quantity of the electrification of the toner is insufficient.

The aromatic-oxy-carboxylic acid iron-including compound as the charge control agent has remarkably a larger specific surface area than that of aromatic-oxy-carboxylic acid aluminum- or zinc-including compound. It is preferable that the specific surface area of the aromatic-oxy-carboxylic acid iron-including compound is 50 to 400 m²/g. When the specific surface area is within the range, the charge control property of the charge control agent is improved more. So when the images are formed, the high definition of the images is achieved. It is further preferable that the specific surface area is 70 to 300 m²/g.

The aromatic-oxy-carboxylic acid iron-including compound has sufficient safety because of low skin sensitivity. And the compound does not cause environment pollution because of not including of harmful matters such as heavy metals.

It is further preferable that the aromatic-oxy-carboxylic acid iron-including compound is 3,5-di-tert-butylsalicylic acid iron-including compound, 5-tert-octylsalicylic acid iron-including compound, 3-hydroxy-2-naphthoic acid iron-including compound, or 3-hydroxy-7-tert-octyl-2-naphthoic acid iron-including compound.

It is furthermore preferable that the aromatic-oxy-carboxylic acid iron-including compound is 3,5-di-tert-butylsalicylic acid iron-including compound. Further concretely, the compounds represented by following chemical formulae [1] to [5] are mentioned. 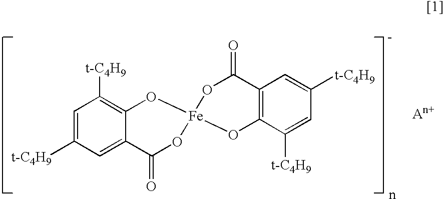
(in the chemical formula [1], Aⁿ⁺ is a hydrogen ion, an alkaline metal ion, an alkaline earth metal ion, an ammonium ion or an organic ammonium ion; n is 1 to 2) 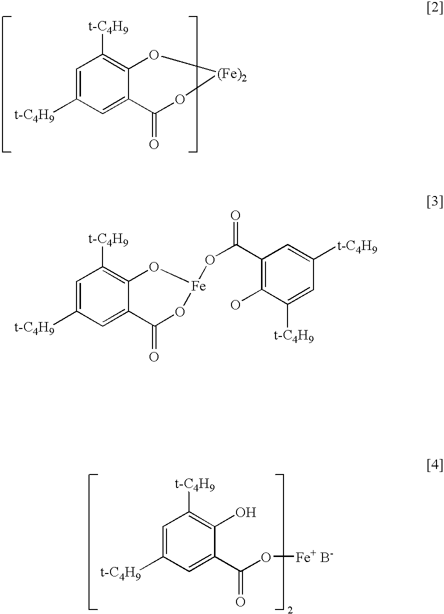
(in the chemical formula [4], B⁻ is an inorganic anion or an organic anion) 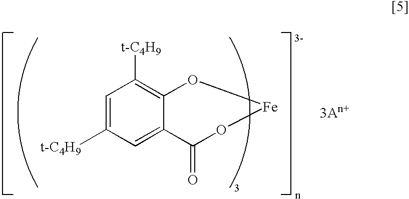
(in the chemical formula [5], Aⁿ⁺ is a hydrogen ion, an alkaline metal ion, an alkaline earth metal ion, an ammonium ion, or an organic ammonium ion; n is 1 to 2)

3,5-di-tert-butylsalicylic acid iron-including compound is preferable because of the electrification property of the toner.

Especially in them, the compound represented by the following chemical formula [6] is furthermore preferable. 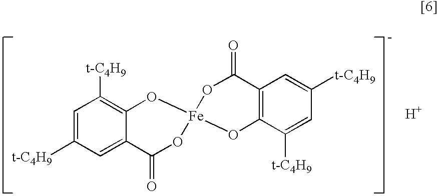
(in the chemical formula [6], t-C₄H₉ is a tert-butyl group)

It is preferable that the aromatic-oxy-carboxylic acid iron-including compound as the charge control agent is amorphous. Being amorphous is confirmed by analysis result of X-ray crystal diffraction method that no clear diffraction peak is indicated. When the aromatic-oxy-carboxylic acid iron-including compound is amorphous, rough granules are pulverized finely, to dissolve in the resin readily in knead procedure of the preparing process of the toner. Consequently, the toner that the charge control agent disperses onto the surface of the particle thereof evenly tends to be prepared. The toner using the amorphous charge control agent causes a fast rise speed of the electrification, the duration of the electrification, and stability of the charge control property of the toner.

If the toner is contaminated by a little impurity, especially inorganic salts, the charge control property is influenced conspicuously. It is preferable that the aromatic-oxy-carboxylic acid iron-including compound for using is purified. It is preferable that the aromatic-oxy-carboxylic acid iron-including compound has the electric conductivity ranging 200 micro S or less. When the electric conductivity is within the range, the compound as the charge control agent quickens the rise speed of the electrification, and improves the electrification property.

The toner for the electrostatic image development may comprise a wax having average molecular weight ranging from 3000 to 10000. When the wax is added, it acts as a mold releasing agent and improves an offset property of the toner furthermore.

An image formation process comprises steps of:
a step for forming a toner layer on a frame holding a developer that is arranged with a aperture towards a frame holding an electrostatic latent image, by absorbing the developer including the above-mentioned toner for electrostatic image development; and
a step for developing the electrostatic latent image by absorbing of the toner in the toner layer onto the frame holding the electrostatic latent image.

According to this process, the vivid images having the high definition are formed. When the process is performed for a long period of time repetitiously, the image that has the high quality and no fogginess is formed.

The toner for the electrostatic image development of the present invention causes the fast rise speed of the electrification, the excellent electrification property. According to the image formation process using the toner, the vivid images having the high quality, high definition and no fogginess are formed after using thereof for a long period of time.

### BRIEF EXPLANATION OF THE DRAWINGS

FIG. 1 is an X-ray crystal diffraction spectrum of the aromatic-oxy-carboxylic acid iron-including compound that is included in the toner for electrostatic image development that applies this invention.

### DETAILED EXPLANATION OF THE INVENTION

Hereunder, embodiments of the toner for the electrostatic image development of this invention are explained in detail.

The toner for the electrostatic image development was made from 3,5-di-tert-butylsalicylic acid iron-including compound of the charge control agent represented by the above chemical formula [1], the binding resin, and the colorant as material components of the toner.

The electric conductivity was determined as follows. 5 g of 3,5-di-tert-butylsalicylic acid iron-including compound was added to 100 g of pure water. It was boiled for 5 minutes, and then an amount of water that corresponds to evaporated water was added. It was cooled until room temperature, and filtrated. The electric conductivity was determined by conductometry of the filtrate. It is preferable that the toner had the electric conductivity ranging 200 micro S or less, because the electrification of the toner is improved highly and stably.

The toner for the electrostatic image development was prepared as follows. The material components of the toner were sufficiently mixed with a mixer such as a ball mill, and then melted and kneaded with a heat kneading machine such as a heating roller, a kneader, and an extruder. It was cooled to solidify. It was pulverized and classified to have the prescribed particle size distribution, and then the toner is obtained. Incidentally, the toner having the prescribed particle size distribution may be prepared from a monomer of resin at a stretch by a granulation polymerization method such as suspension polymerization and emulsion polymerization.

The particle size distribution was determined as follows. A particle size distribution determination apparatus selected from Coulter Counter TA-II and Multisizer that were available from Beckman Coulter Inc. was used for the determination.

Beforehand, 1% of NaCl aqueous solution as an electrolytic solution was prepared using extra pure sodium chloride. Into 100 to 150 ml of the electrolytic solution, a surface active agent as a dispersing agent such as 0.2 to 5 mL of alkylbenzenesulfonic acid salt was added, and then 2 to 20 mL of the toner as the determination sample was added to suspend. The suspended electrolytic solution was dispersed for 2 minutes using a supersonic dispersion machine. 100 micro L thereof was used as an aperture. The volume and the number of the toner having the size of 2 microns or more were determined using the particle size distribution determination apparatus. Then its volume distribution was determined. As regards the particle size distribution, the cumulative volume particle diameter from the largest particle diameter was determined. The volume-average particle diameter (D₅₀) that was determined by the cumulative 50% volume particle diameter, a cumulative 25% volume particle diameter (D₂₅) and a cumulative 75% volume particle diameter (D₇₅) are determined from the largest particle diameter as same.

The toner for the electrostatic image development having its particle size distribution was prepared by the classification to have the volume-average particle diameter (D₅₀) ranging from 5 to 13 microns and the degree of particle size dispersion (D₂₅/D₇₅) ranging from 1.20 to 1.50 that was calculated by the cumulative 25% volume particle diameter (D₂₅) and the cumulative 75% volume particle diameter (D₇₅).

The known synthetic resins and natural resins are used as the binding resin that is included in the toner for the electrostatic image development.

Examples of the binding resin are styrene homopolymer or substituted-styrene homopolymer such as polystyrene, poly-p-chlorostyrene, and polyvinyltoluene; styrene type copolymer such as styrene-p-chlorostyrene copolymer, styrene-vinyltoluene copolymer, styrene-vinylnaphthalene copolymer, styrene-acrylate copolymer, styrene-methacrylate copolymer, styrene-methyl alpha-chloromethacrylate copolymer, styrene-acrylonitrile copolymer, styrene-vinyl methyl ether copolymer, styrene-vinyl ethyl ether copolymer, styrene-vinyl methyl ketone copolymer, styrene-butadiene copolymer, styrene-isoprene copolymer, and styrene-acrylonitrile-indene copolymer.

Examples of co-monomer reacted with styrene monomer of the styrene type copolymer are monocarboxylic acid derivative having a double bond and substituted derivative thereof such as acrylic acid, methyl acrylate, ethyl acryldte, butyl acrylate, dodecyl acrylate, octyl acrylate, 2-ethylhexyl acrylate, phenyl acrylate, methacrylic acid, methyl methacrylate, ethyl methacrylate, butyl methacrylate, octyl methacrylate, acrylonitrile, and acrylamide; dicarboxylic acid derivative having a double bond and substituted derivative thereof such as maleic acid, butyl maleate, methyl maleate, and dimethyl maleate; vinyl ester derivative such as vinyl chloride, vinyl acetate, and vinyl benzoate; ethylene type olefin derivative such as ethylene, propylene, and butylene; vinyl ketone derivative such as vinyl methyl ketone, and vinyl hexyl ketone; vinyl ether derivative such as vinyl methyl ether, vinyl ethyl ether, and vinyl isobutyl ether. The exemplified co-monomer may be used solely or plurally with mixing.

The binding resin may be the styrene type polymer cross-linked by a cross linking agent. As the cross linking agent, compounds having two or more double bonds that are able to polymerize are used. Examples of the cross linking agent are aromatic divinyl derivative such as divinylbenzene, divinylnaphthalene; carboxylate derivative having two double bonds such as ethylene glycol diacrylate, ethylene glycol dimethacrylate, and 1,3-butanediol dimethacrylate; divinyl derivative such as divinylaniline, divinyl ether, divinyl sulfide, and divinyl sulfone; and derivatives having three or more vinyl groups. The exemplified cross linking agent may be used solely or plurally with mixing.

The binding resin may be polyvinyl chloride, phenol resin, natural resin-denatured phenol resin, natural resin-denatured maleic acid resin, acrylic resin, methacrylic resin, polyvinyl acetate, silicone resin, polyester resin, polyurethane resin, xylene resin, polyamide resin, furan resin, epoxy resin, polyvinyl butyral, terpene resin, cumarone-indene resin, petroleum resin.

Examples of the colorant included in the toner are carbon black, aniline black, calcoil blue, chrome yellow, ultramarine blue, oil red, quinoline yellow, methylene blue chloride, copper phthalocyanine, malachite green oxalate, lamp black, rose bengale, C.I. pigment red 48:1, C.I. pigment red 122, C.I. pigment red 57:1, C.I. pigment yellow 97, C.I. pigment yellow 12, C.I. pigment yellow 17, C.I. pigment blue 15:1, and C.I. pigment blue 15:3.

The mold releasing agent may be added in the toner for the electrostatic image development. It is preferable that the mold releasing agent are paraffin having 8 or more carbon atoms such as paraffin wax, paraffin latex, and microcrystalline wax; polyolefin such as polypropylene wax, polyethylene wax. The exemplified mold releasing agent may be used solely or plurally with mixing. It is preferable that the additive amount of the mold releasing agent ranges from 0.3 to 10 weight %. If the additive amount of the mold releasing agent is less than 0.3 weight %, it acts as the mold releasing agent insufficiently in the occasion of the fixing of the images. If the additive amount thereof is more than 10 weight %, it causes defective electrification, scattering of the toner from the frame holding the developer and declining of the quality of the images, because of increasing of exposure thereof on the surface of the toner. And it causes declining cleaning property because of increasing of adhesion between the toner particles, or interaction between the toner and the layer formation blade or the frame holding the developer.

A magnetic toner including a magnetic material may be added in the toner for the electrostatic image development. Examples of the magnetic material are metallic oxides including an element such as iron, cobalt, nickel, copper, magnesium, manganese, and zinc. It is preferable that the magnetic material has BET specific surface area determined by a nitrogen absorption method ranging from 1 to 20 m²/g, further preferably from 2.5 to 12 m²/g, and is magnetic powder having Moh's hardness ranging from 5 to 7. The magnetic material has generally a shape of octahedron, hexahedron, globe, needle, or scale. It is preferable that the magnetic material has the shape of little anisotropy such as the octahedron, the hexahedron, the globe, and so on. Particularly, the magnetic material having the shape of the isotropy accomplishes the sufficient dispersion to the binding resin and the wax in the toner. The magnetic material has an average particle size ranging preferably from 0.05 to 1.0 microns, further preferably from 0.1 to 0.6 microns, furthermore preferably from 0.1 to 0.4 microns.

Preferably 50 to 200 weight parts, further preferably 70 to 150 weight parts of the magnetic material are added to 100 weight parts of the binding resin of the toner. If the magnetic material is less than 50 weight parts, a carrier property of the toner is insufficient, the developer layer on the frame holding the developer causes unevenness, the images tend to be uneven, and the concentration of the image tends to decrease because of raising of the electrification of the developer excessively. If the magnetic material is more than 200 weight parts, the concentration of the image tends to decrease because of the insufficient electrification of the developer.

Inorganic fine powder or hydrophobic inorganic fine powder may be added to the toner for the electrostatic image development for improving of environmental stability, electrification stability, development property, fluidity, and shelf life. Examples of the powder are the fine silica powder, the fine titanium oxide powder, and a hydrophobic-treated material thereof. The powder may be used solely or plurally with mixing.

As the fine silica powder, dry silica prepared from silicon halide by oxidative vapor deposition that is called a dry-type method; other dry silica that is called fumed silica; other dry silica conjugated fine powder of silica and another metal oxide prepared from metal halide such as aluminum chloride or titanium chloride and silicon halide; so-called wet silica prepared from water glass and so on are mentioned. Especially, the dry silica, that has only a few silanol groups on its surface or its inside and has little preparative residual group such as Na₂O, SO₃²⁻ and so on, is preferable.

It is preferable that the fine silica powder is the hydrophobic-treated material thereof. The hydrophobic-treatment has a procedure of treating with an organic silicon compound and so on that reacts or physically absorbs to the fine silica powder. It is preferable that the hydrophobic-treatment has the procedure of treating the fine dry powder prepared from silicon halide by oxidative vapor deposition with a silane coupling agent, and the simultaneous or continuous procedure of treating with the organic silicon compound such as silicone oil.

Examples of the silane coupling agent used for the hydrophobic-treatment, are hexamethylenedisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, alpha-chloroethyltrichlorosilane, beta-chloroethyltrichlorosilane, chloromethyldimethylchlorosilane, triorganosilylmercaptan, trimethylsilylmercaptan, triorganosilylacrylate, vinyldimethylacetoxysilane, dimethyldiethoxysilane, dimethyldimethoxysilane, diphenyidiethoxysilane, hexamethyldisiloxane, 1,3-divinyltetramethyldisiloxane, 1,3-diphenyltetramethyidisiloxane, and dimethylpolysiloxane that has 2 to 12 siloxane units per one molecule and has each of the terminal units having a hydroxyl group bound to a silicon atom.

An example of the organic silicon compound is silicone oil. Preferable examples of the silicon oil are dimethylsilicone oil, methylphenylsilicone oil, alpha-methylstyrene-denatured silicone oil, chlorophenylsilicone oil, fluorine-denatured silicone oil.

The treatment with the silicone oil may have the procedure of direct mixing of the silicone oil and the fine silica powder treated with the silane coupling agent using a mixer such as a Henschel mixer. It may have the procedure of spraying of the silicone oil to the fine silica powder as a base. It may have the procedures of dissolving or dispersing of the silicone oil to a suitable solvent, mixing the fine silica powder thereto, and then removing the solvent.

Another external additive agent except for the fine silica powder or the fine titanium oxide powder may be added to the toner for the electrostatic image development, if necessary.

Examples of the external additive agent are fine resin powder and fine inorganic powder that acts as an electrostatic auxiliary, a conductive provider agent, a fluid provider agent, a caking inhibitor, a mold releasing agent for heat roller fixing, a lubricant, an abrasive material, a development improver.

Examples of the lubricant are polytetrafluoroethylene, zinc stearate, and polyvinylidene fluoride.

Examples of the abrasive material are cerium oxide, silicon carbide, and strontium titanate.

Examples of the fluid provider agent are titanium dioxide, and aluminum oxide. Especially the hydrophobic fluid provider agent is preferable.

Examples of the conductive provider agent are carbon black, zinc oxide, antimony oxide, and tin oxide.

An example of the development improver is a small amount of black fine particles or white fine particles having reversed polarity.

It is preferable that the inorganic fine powder, the hydrophobic inorganic fine powder, and the external additive agent are used 0.05 to 3 weight parts thereof to 100 weight parts of the toner.

Hereunder, embodiments of the image formation process are explained in detail.

The image formation process comprises orderly steps of:
a step for forming the latent image on the frame holding the latent image,
a step for developing that the latent image is developed on the frame holding the latent image using the developer layer, which is formed onto the frame holding the developer, to form the toner images,
a step for transferring that the toner images are transferred to a transcription sheet,
a step for cleaning,
and a step for fixing that the toner images on the transcription sheet are fixed thermally.

In regard to the step for forming the latent image, the electrostatic latent image is formed by a known method such as an electrophotography method or an electrostatic recording method on a photosensitive frame holding the latent image, that consist of a photosensitive layer or a dielectric layer and a cylindrical frame having thereof. The photosensitive layer is made from materials such as an organic compound and amorphous silicon. The cylindrical frame having the photosensitive layer is prepared by injection molding of aluminum or aluminum alloy and processing of surface finishing.

In regard to the step for developing, the thin developer layer is formed using a layer-formation blade such as an elastic blade onto the frame holding the developer as a rotating cylindrical development roll, it is conveyed to a development position, bias voltage is applied between the development roll and the frame holding the latent image, the electrostatic latent image is developed by the developer, and then the toner images are formed. The development roll and the frame holding the latent image contact at the development position and are arranged with a fixed aperture.

Examples of the frame holding the one-component developer used as one of the frame holding the developer are a elastic sleeve made of silicone rubber; a sleeve which ceramics or metal such as aluminum and stainless steel (SUS) is drawn to prepare; a sleeve of which the surface is treated by oxidizing, polishing, blasting or resin-coating in order to control the conveyance property and the electrification property of the toner. The toner layer is formed onto the development roll by contacting between of the layer-formation blade and the surface of the sleeve. When the layer-formation blade is the elastic blade, it is preferable that its material is elastic rubber such as silicone rubber and urethane rubber. The material may be made from the elastic body which organic or inorganic material is added and dispersed in order to control the quantity of electrification of the toner.

Examples of the frame holding the two-component developer used as another frame holding the developer are a sleeve made of metal such as aluminum, SUS and brass; a sleeve which the surface is treated by oxidizing, polishing or blasting in order to control the conveyance property and the electrification property of the toner. The developer is formed onto a development roller with separating between the layer-formation blade and the surface of the sleeve slightly.

In regard to the step for transferring, the toner image on the frame holding the latent image is transferred to the paper as the transcription sheet. Examples of the transferring procedure are a contact-type procedure of contacting the transferring roll device onto the frame holding the latent image with pressure; and a noncontact-type procedure using corotron. The contact-type procedure is preferable because of using the small-size device.

In regard to the step for cleaning, a cleaner removes the residual toner that is not transferred on the step for transferring. Example of the step for cleaning is a procedure using of a cleaning blade or a cleaning roll. The cleaning blade made from the elastic rubber such as silicone rubber and urethane rubber is used.

In regard to the step for fixing, a fixing device fixes the transferred toner image on the transcription sheet. The step for fixing is preferably a thermal fixing procedure using a heat roll. It may be a pressure fixing procedure.

Hereunder, embodiments of the toner for the electrostatic image development that applies this invention are explained in detail.

Beforehand, 3,5-di-tert-butylsalicylic acid iron-including compound was prepared as follows.

### (SYNTHETIC EXAMPLE 1: THE SALICYLIC ACID IRON-INCLUDING COMPOUND)

100 g of 3,5-di-tert-butylsalicylic acid and 30 g of sodium hydroxide were dissolved in 1 L of water at 60 degrees centigrade. The solution was added dropwise to a solution of 43 g of ferric chloride and 1 L of water. It was reacted with stirring for 2 hours at 90 degrees centigrade. The reaction mixture was filtrated. The obtained residue was washed to purify. It was dried and pulverized finely, to obtain 110 g of 3,5-di-tert-butylsalicylic acid iron-including compound represented by the above-mentioned chemical formula [6].

When the electric conductivity of 3,5-di-tert-butylsalicylic acid iron-including compound was determined by the above-mentioned determination procedure, it was 176 micro S.

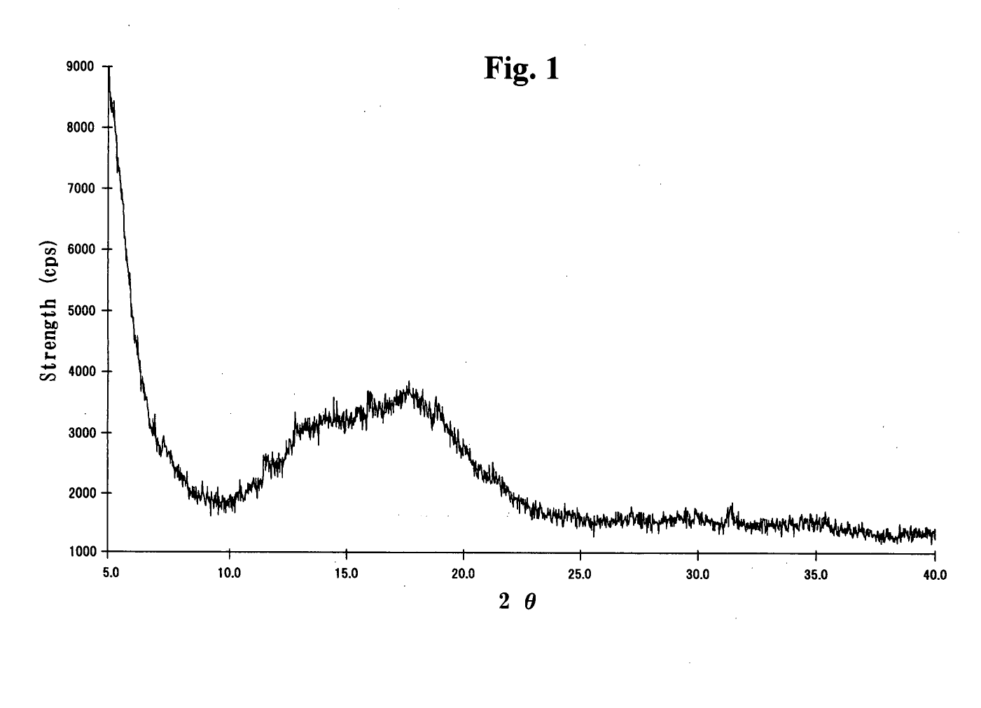

X-ray diffraction peaks of 3,5-di-tert-butylsalicylic acid iron-including compound were measured by CuKₐ characteristic X-ray having wavelength 1.54 angstrom using X-ray powder diffraction instrument MXP-18 that is available from Mac Science corporation. The result was indicated in FIG. 1. As shown in FIG. 1, clear diffraction peaks were not observed obviously, and it was assumed that 3,5-di-tert-butylsalicylic acid iron-including compound is amorphous.

When the specific surface area of the above 3,5-di-tert-butylsalicylic acid iron-including compound was determined by a nitrogen absorption method under liquid nitrogen atmosphere using Autosorb 3 that is available from Quantachrome corporation, it was 118.0 m²/g.

Examples of preparing of the toner for electrostatic image development that applies the present invention, and Comparative Examples of preparing of other toner for the electrostatic image development that does not apply the present invention, are described. Examples of the preparing of the toner

### (EXAMPLES 1 TO 3)

100 weight parts of styrene-butyl acrylate copolymer of which weight average molecular weight Mw was 178000 and number average molecular weight Mn was 18000, 1 weight part of 3,5-di-tert-butylsalicylic acid iron-including compound of the above Synthetic Example 1, 6 weight parts of carbon black MA-100 that is available from Mitsubishi Chemical Corporation, and 3 weight parts of wax of which average molecular weight is 4000 are beforehand mixed homogenously. It was melted and kneaded using a biaxial extruder heated at 160 degrees centigrade. The kneaded mixture was cooled, crushed roughly using a hammer mill. Then it was pulverized finely using a jet mill. The obtained pulverized powder was classified by wind force to obtain seven fractions of classified powder. The particle size distribution of each fraction of the classified powder was determined by the above-mentioned procedure. Three fractions having respectively the volume-average particle diameter (D₅₀) ranging from 5 to 13 microns and the degree of particle size dispersion (D₂₅/D₇₅) ranging from 1.20 to 1.50 were elected. 1.0 weight parts of the fine hydrophobic silica powder was added to 100 weight parts of that of each elected fraction of classified powder. It was dry-blended to obtain the toner of Examples 1 to 3 respectively. In Table 1, the initial values of D_{25/}D₇₅ were indicated.

### (Comparative Examples 1-4)

In Comparative Examples 1 to 2, the fractions of the classified powder were prepared as same as Examples 1 to 3. And the two elected fractions of the classified powder, which have the volume-average particle diameter (D₅₀) and the degree of particle size dispersion (D₂₅/D₇₅) ranging outside the above ranges, were used. The fine hydrophobic silica powder was added thereto as same as Example 1. It was dry-blended to obtain the toner of Comparative Examples 1 to 2 respectively. In Table 1, the initial values of D₂₅/D₇₅ were indicated.

In Comparative Examples 3 to 4, the fractions of the classified powder were prepared as same as Examples 1 to 3 except for using 3,5-di-tert-butylsalicylic acid zinc-including compound instead of 3,5-di-tert-butylsalicylic acid iron-including compound of Examples 1 to 3. The elected fractions of the classified powder, which have the volume-average particle diameter (D₅₀) and the degree of particle size dispersion (D₂₅/D₇₅) ranging outside the above ranges, were used. The fine hydrophobic silica powder was added thereto as same as Example 1. It was dry-blended to obtain the toner of Comparative Examples 3 to 4 respectively. In Table 1, the initial values of D₂₅/D₇₅ were indicated.

Continuously, Examples of preparing of the developer using the toner that applies the present invention, and Comparative Examples of preparing of the developer using other toner that does not apply the present invention, are described.

Preparing of the Two-Component Developer

### (EXAMPLE 4)

100 weight parts of the silicone-coated amorphous carrier as the carrier was added to 5 weight parts of the toner prepared in Example 1. It was mixed to obtain the developer of Example 4.

The quantity of electrification of the developer Q/M (micro C/g) is measured using a blow-off measuring instrument of the quantity of the electrification MODEL TB-200, that is available from Toshiba Chemical Corporation.

Commercially available laser beam printer formed the images onto the copy paper as the transcription sheets using the developer. The images were formed onto 20000 sheets of the copy paper. In regard to every 5000 sheets of the copy paper that formed the images, the quantity of the blow-off electrification, the volume-average particle diameter (D50) and the degree of particle size dispersion (D₂₅/D₇₅) were measured, and the quality of the images was observed visually.

The quality of the images was evaluated by the following four ranks.

O; The images had the even concentration thereof and the excellent output.

Δ; The images had the more or less even concentration thereof and practically no problem.

Δ-X; The images had the uneven concentration thereof, and the uneven and blurred output.

X; The images had the remarkably uneven concentration thereof, and the remarkably uneven and blurred output.

### (EXAMPLES 5 TO 6, AND COMPARATIVE EXAMPLES 5 TO 8)

In Examples 5 to 6, the developers of Examples 5 to 6 were prepared as same as Example 4 except for using the toners in Example 2 to 3 instead of the toner of Example 1 that is used in Example 4.

In Comparative Examples 5 to 8, the developers of Comparative Examples 5 to 8 were prepared as same as Example 4 except for using the toners in Comparative Example 1 to 4 instead of the toner of Example 1 that is used in Example 4.

The images were formed onto 5000 to 20000 sheets using the above-mentioned developer. The quantity of the blow-off electrification, the volume-average particle diameter (D₅₀) and the degree of particle size dispersion (D₂₅/D₇₅) were measured with the passage of time.

TABLE 1

| | Measure- | Forming of Images | | | | |
|---|---|---|---|---|---|---|
| | ment | | 5000 | 10000 | 15000 | 20000 |
| | Item | Initial | Sheets | Sheets | Sheets | Sheets |
| Example 4 | Q/M | −27.5 | −24.5 | −23.4 | −24.0 | −23.8 |
| | (micro C/g) | | | | | |
| | D₅₀ | 6.0 | 6.0 | 6.1 | 6.1 | 6.0 |
| | (micron) | | | | | |
| | D₂₅/D₇₅ | 1.37 | 1.34 | 1.34 | 1.34 | 1.35 |
| | Quality of | ◯ | ◯ | ◯ | ◯ | ◯ |
| | Image | | | | | |
| Example 5 | Q/M | −23.6 | −21.4 | −20.7 | −20.8 | −21.2 |
| | (micro C/g) | | | | | |
| | D₅₀ | 8.8 | 9.0 | 9.1 | 9.1 | 9.1 |
| | (micron) | | | | | |
| | D₂₅/D₇₅ | 1.27 | 1.26 | 1.28 | 1.27 | 1.28 |
| | Quality of | ◯ | ◯ | ◯ | ◯ | ◯ |
| | image | | | | | |
| Example 6 | Q/M | −16.2 | −16.2 | −14.9 | −16.0 | −15.4 |
| | (micro C/g) | | | | | |
| | D₅₀ | 11.7 | 11.7 | 11.8 | 11.8 | 11.8 |
| | (micron) | | | | | |
| | D₂₅/D₇₅ | 1.26 | 1.30 | 1.31 | 1.31 | 1.30 |
| | Quality of | ◯ | ◯ | ◯ | ◯ | ◯ |
| | Image | | | | | |
| Comparative | Q/M | −36.8 | −54.1 | −47.1 | −42.8 | −43.2 |
| Example 5 | (micro C/g) | | | | | |
| | D₅₀ | 6.3 | 5.9 | 6.5 | 6.0 | 6.3 |
| | (micron) | | | | | |
| | D₂₅/D₇₅ | 1.56 | 1.77 | 1.77 | 1.73 | 1.81 |
| | Quality of | Δ | X | X | X | X |
| | Image | | | | | |
| Comparative | Q/M | −26.6 | −23.1 | −19.1 | −17.4 | −18.2 |
| Example 6 | (micro C/g) | | | | | |
| | D₅₀ | 8.7 | 9.8 | 9.9 | 10.1 | 10.5 |
| | (micron) | | | | | |
| | D₂₅/D₇₅ | 1.65 | 1.70 | 1.71 | 1.70 | 1.71 |
| | Quality of | ◯ | Δ-X | Δ-X | Δ-X | Δ-X |
| | Image | | | | | |
| Comparative | Q/M | −17.3 | −16.6 | −15.2 | −14.4 | −14.6 |
| Example 7 | (micro C/g) | | | | | |
| | D₅₀ | 12.1 | 13.4 | 13.8 | 14.1 | 14.3 |
| | (micron) | | | | | |
| | D₂₅/D₇₅ | 1.55 | 1.70 | 1.74 | 1.74 | 1.76 |
| | Quality of | Δ | Δ | Δ | X | X |
| | Image | | | | | |
| Comparative | Q/M | −14.2 | −13.2 | −11.1 | −11.4 | −12.2 |
| Example 8 | (micro C/g) | | | | | |
| | D₅₀ | 14.5 | 16.3 | 16.6 | 16.4 | 16.7 |
| | (micron) | | | | | |
| | D₂₅/D₇₅ | 1.58 | 1.59 | 1.55 | 1.57 | 1.57 |
| | Quality of | Δ | X | X | X | X |
| | Image | | | | | |

Table 1 indicates as follows obviously.

When the images are formed using the developers including the toner for the electrostatic image development that applies the present invention as Examples 4 to 6, it causes the excellent electrification property, the vivid image maintaining high definition, high quality and little fogginess for a long period of time of using thereof.

When the images are formed using the developers including the toner for the electrostatic image development that does not apply the present invention, it causes the terrible quality of images.

1. A toner for electrostatic image development comprising components of:
a charge control agent of an aromatic-oxy-carboxylic acid iron-including compound substituted by at least one substitutional group selected from groups consisting of an alkyl group having 1 to 12 carbon atoms, an alkenyl group having 2 to 12 carbon atoms, —OH, —NH₂, —NH(CH₃), —N(CH₃)₂, —OCH₃, —O(C₂H₅), —COOH and —CONH₂,
a binding resin,
and colorant;
and having its particle size distribution with:
a volume-average particle diameter (D₅₀) ranging from 5 to 13 microns that is determined by a cumulative 50% volume particle diameter from a largest particle diameter,
and a degree of particle size dispersion (D₂₅/D₇₅) ranging from 1.20 to 1.50 that is calculated by a cumulative 25% volume particle diameter (D₂₅) and a cumulative 75% volume particle diameter (D₇₅) as same as the above determined D₅₀.

2. The toner according to claim 1, wherein the aromatic-oxy-carboxylic acid iron-including compound is 3,5-di-tert-butylsalicylic acid iron-including compound, 5-tert-octylsalicylic acid iron-including compound, 3-hydroxy-2-naphthoic acid iron-including compound, or 3-hydroxy-7-tert-octyl-2-naphthoic acid iron-including compound.

3. The toner according to claim 1, wherein the aromatic-oxy-carboxylic acid iron-including compound is the 3,5-di-tert-butylsalicylic acid iron-including compound represented by following chemical formula.

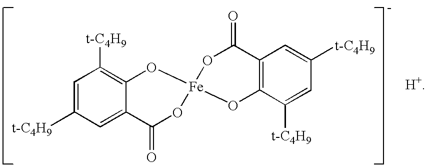

4. The toner according to claim 1, wherein the aromatic-oxy-carboxylic acid iron-including compound has a specific surface area ranging from 50 to 400 m²/g.

5. The toner according to claim 1, wherein the aromatic-oxy-carboxylic acid iron-including compound is amorphous.

6. The toner according to claim 1, wherein the aromatic-oxy-carboxylic acid iron-including compound has electric conductivity ranging 200 micro S or less.

7. The toner according to claim 1, comprises a wax having average molecular weight ranging from 3000 to 10000.

8. An image formation process comprising steps of:
a step for forming a toner layer on a frame holding a developer that is arranged with a aperture towards a frame holding an electrostatic latent image by absorbing the developer including of a toner for electrostatic image development comprises components of;
a charge control agent of an aromatic-oxy-carboxylic acid iron-including compound substituted by at least one substitutional group selected from groups consisting of an alkyl group having 1 to 12 carbon atoms, an alkenyl group having 2 to 12 carbon atoms, —OH, —NH₂, —NH(CH₃), —N(CH₃)₂, —OCH₃, —O(C₂H₅), —COOH and —CONH₂,
a binding resin,
and colorant;
and has its particle size distribution with:
a volume-average particle diameter (D₅₀) ranging from 5 to 13 microns that is determined by a cumulative 50% volume particle diameter from a largest particle diameter,
and a degree of particle size dispersion (D₂₅/D₇₅) ranging from 1.20 to 1.50 that is calculated by a cumulative 25% volume particle diameter (D₂₅) and a cumulative 75% volume particle diameter (D₇₅) as same as the above determined D₅₀;
a step for developing the electrostatic latent image by absorbing of the toner in the toner layer onto the frame holding the electrostatic latent image.

9. The image formation process according to claim 8, wherein the aromatic-oxy-carboxylic acid iron-including compound is 3,5-di-tert-butylsalicylic acid iron-including compound, 5-tert-octylsalicylic acid iron-including compound, 3-hydroxy-2-naphthoic acid iron-including compound, or 3-hydroxy-7-tert-octyl-2-naphthoic acid iron-including compound.

10. The image formation process according to claim 8, wherein the aromatic-oxy-carboxylic acid iron-including compound is the 3,5-di-tert-butylsalicylic acid iron-including compound represented by following chemical formula.

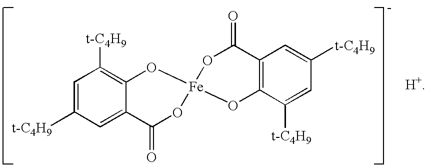

11. The image formation process according to claim 8, wherein the aromatic-oxy-carboxylic acid iron-including compound has a specific surface area ranging from 50 to 400 m²/g.

12. The image formation process according to claim 8, wherein the aromatic-oxy-carboxylic acid iron-including compound is amorphous.

13. The image formation process according to claim 8, wherein the aromatic-oxy-carboxylic acid iron-including compound has electric conductivity ranging 200 micro S or less

14. The image formation process according to claim 8, wherein the toner comprises a wax having average molecular weight ranging from 3000 to 10000.
